(19) United States
(12) Patent Application Publication
(10) Pub. No.: US 2003/0114626 A1
(43) Pub. Date: Jun. 19, 2003

(54) Polyurethane hot-melt adhesives for the production of cork stoppers

(76) Inventors: Uwe Franken, Dormagen (DE); Hartmut Primke, Bopfingen (DE); Carlos De Alvaro, Barcelona (ES)

Correspondence Address: Stephen D. Harper, Esq., Henkel Corporation, Suite 200, 2500 Renaissance Blvd., Gulph Mills, PA, 19406, US

(21) Appl. No.: 10/183,715

(22) Filed: Jun. 27, 2002

(30) Foreign Application Priority Data
Jun. 27, 2001 (DE) 10130887.6

(51) Int. Cl. C08L 1/00

(52) U.S. Cl. 528/44; 524/16

(57) ABSTRACT

Reactive hot-melt adhesive with a softening-point between 90° C. and 160° C.—in particular reactive polyurethane hot-melt adhesives—are suitable for the adhesion bonding of mouldings made of agglomerated cork to discs made of natural cork. In this way it is possible for high-quality cork-stopper composites for the sealing of beverage bottles to be produced in very efficient and cost-effective manner.

The present invention relates to the use of a reactive hot-melt adhesive for the production of cork stoppers and also to a process for the production of cork stoppers and to the use of cork stoppers produced in such a manner.

Bottle-corks have been used since time immemorial for the sealing of bottles that contain high-quality beverages, in particular alcoholic beverages such as wine or sparkling wines (Champagne, Cava or Sekt). Traditionally such corks are stamped out of the phellem of the cork oak (Quercus suber); this isolation of cork is known to be limited to a few regions of the earth in which the cork oaks are grown economically and the cork bark can be isolated. These regions are essentially limited to the countries Portugal and Spain as well as, to a lesser extent, France, Italy, Algeria, Morocco and Tunisia. The demand for natural cork for packaging the aforementioned high-quality beverages exceeds by far the global production capacity of qualitatively flawless cork material. Good cork is light brown, dense and elastic; its cells are hollow and filled with air. Inferior qualities of natural cork frequently have defects, such as, for example, porous, honeycombed and floury cell-wall material or larger cavities in the cork material, which can give rise to deficient imperviousness of the cork stopper and hence can have a negative influence on the quality of the stored product. Moreover, corks may contain certain contaminants, from which the musty-odourous, extremely strong-smelling 2,4,6-trichloroanisole is formed, inter alia, in the course of chlorine bleaching. With wines, this leads to the so-called “corked taste” which can considerably influence or jeopardise the quality of the stored product.

There has been no shortage of attempts, therefore, to provide bottle closures as alternatives to the high-quality natural-cork stopper. For instance, many wines are offered in bottles with screw caps which contain a plastic seal. Patent Application CA-A-1177600 describes and claims a method for producing stoppers from plastic material, such as ethylene/vinyl-acetate copolymers for example, by injection moulding. U.S. Pat. No. 4,042,543 describes a composition for producing stoppers containing polyethylene or ethylene/vinyl-acetate copolymers which are mixed with particles of natural cork. To this end, the constituents are mixed and heated to temperatures of about 250° C., in order to melt down the copolymer and to distribute the cork particles therein. U.S. Pat. No. 5,317,047 describes compositions made of ligneous plant materials such as natural cork or wood which are bound with a polymeric binding agent such as, for example, polyurethanes or acrylates and which, moreover, contain plastic material with closed-cell structure, such as expandable hollow microbeads, for example, as well as the use thereof for producing stoppers for bottles.

However, such obvious “substitutes” for natural cork are not accepted by connoisseurs of high-quality alcoholic beverages. As an alternative, so-called cork agglomerates are therefore proposed which permit high-quality cork material to be utilised more efficiently. For this purpose the residues arising in the production of cork stoppers and blending material are granulated and bound with binding agents such as adhesive dispersions or even liquid or pasty polyurethane adhesives so as to form plate-like mouldings from which the cork stoppers can be stamped out. A further method forms similar agglomerated corks from the mixture consisting of triturated cork material and binding agents in the continuous string-extrusion process. For reasons concerning quality, such as, for example, tastelessness in relation to the product that is stored in the bottle, or even the strength of the cork, agglomerated corks are frequently joined together with thin discs made of natural cork so as to form combined cork composites. A process of such a type is described in U.S. Pat. No. 4,521,266, for example. The adhesion bonding of the natural-cork discs to cork-agglomerate mouldings with the aid of dispersion adhesives based on polyurethane or acrylate is known in the state of the art. This use of dispersion adhesives conceals the disadvantage that, after application of adhesive has taken place, the cork elements to be adhesion-bonded have to be dried, with relatively high expenditure of energy and time, in order to guarantee the necessary strength of the bonded joint. In order to be able to achieve a high production capacity in terms of pieces per unit time, appropriately large and expensive drying devices have to be employed. There has already been an attempt to improve this joining process with the aid of hot-melt adhesives instead of the aforementioned dispersions. However, high demands are made of the adhesive, such as

media resistance in relation to alcohol, acids, hydrolysis,

temperature resistance, since the corks are boiled for the purpose of cleaning and, after adhesion bonding has taken place, are ground to the requisite shape and contour,

flexibility and strength—compression and squeezing of the cork moulding occur in the course of inserting and removing the cork,

the adhesive has to exhibit good adhesion to the cork substrate,

short setting-times with a view to achieving high productivity,

the binding agent has to have the relevant food-regulation licence (e.g. FDA §175.105).

In view of this state of the art, the inventors have set themselves the task of making available a reactive hot-melt adhesive that permits mouldings made of agglomerated cork and natural cork to be adhesion-bonded to one another in such a way that high-quality corks can be produced that are suitable for the sealing of beverage bottles for high-quality beverages.

The solution to the task, according to the invention, can be gathered from the Claims. It consists, essentially, in the use of reactive hot-melt adhesives that, prior to curing, exhibit a softening-point according to ASTM E28 between 90° C. and 160° C., preferably between 100° C. and 150° C., in particularly preferred manner between 110° C. and 130° C., for the adhesion bonding of mouldings made of cork. The hot-melt adhesives with a softening-point according to ASTM E28 between 90° C. and 160° C. are preferably used for the purpose of adhesion-bonding a moulding made of agglomerated cork on one or both end faces to a disc made of natural cork.

In a preferred production process the reactive hot-melt adhesive with a softening-point between 90° C. and 160° C., preferably between 100° C. and 150° C., in particularly preferred manner between 110° C. and 130° C., is heated to a temperature above the softening-point and applied onto at least one end face of the moulding made of agglomerated cork with the aid of a die or a punch-like applicator, in the manner of screen printing, through appropriately shaped perforated plates pertaining to the application punch. Subsequently a cork disc made of natural cork is applied onto the still liquid, softened hot-melt adhesive. After the adhesive joint has become cold, the adhesive bond offers sufficient processing strength for the subsequent stages of machining the cork. These further machining stages may include boiling and washing in aqueous media and also a mechanical aftertreatment of the bonded moulding by grinding or cutting and polishing as well as marking with branding punches, so that the definitive fabricated form of the cork is obtained. Application of the hot-melt adhesive can be effected in this process with conventional processing machines; application is preferably effected with the aid of a die in the spinning/spraying process or with specially shaped application punches in the manner of screen printing through appropriately shaped perforated plates pertaining to the application punch.

Such a hot-melt adhesive preferably consists of polyurethane binding agents, i.e. conversion products formed from polyols with monomeric diisocyanates or polyisocyanates, optionally subject to addition of catalysts. These hot-melt adhesives may optionally contain further conventional hot-melt-adhesive constituents, such as tackifying resins, waxes, stabilisers, commercially available plasticisers and wetting agents.

Monomeric diisocyanates or polyisocyanates in the sense of this invention are those aromatic, aliphatic or cycloaliphatic diisocyanates which have a molecular weight of less than 500. Examples of suitable aromatic diisocyanates are all the isomers of toluylene diisocyanate (TDI), either in pure-isomer form or as a mixture of several isomers, 1,5-naphthalene diisocyanate (NDI), 1,4-naphthalene diisocyanate (NDI), 4,4′-diphenylmethane diisocyanate (MDI), 2,4′-diphenylmethane diisocyanate as well as mixtures of 4,4′-diphenylmethane diisocyanate with the 2,4′ isomer, xylylene diisocyanate (XDI), 4,4′-diphenyldimethylmethane diisocyanate, di- and tetraalkyldiphenylmethane diisocyanate, 4,4′-dibenzyl diisocyanate, 1,3-phenylene diisocyanate, 1,4-phenylene diisocyanate. Examples of suitable cycloaliphatic diisocyanates are the hydrogenation products of the aforementioned aromatic diisocyanates, such as, for example, 4,4′-dicyclohexylmethane diisocyanate (H₁₂MDI), 1-isocyanatomethyl-3-isocyanato-1,5,5-trimethylcyclohexane (isophorone diisocyanate, IPDI), 1,4-cyclohexane diisocyanate, hydrogenated xylylene diisocyanate (H₆XDI), 1-methyl-2,4-diisocyanatocyclohexane, m- or p-tetramethylxylene diisocyanate (m-TMXDI, p-TMXDI) and dimer fatty acid diisocyanate. Examples of aliphatic diisocyanates are 1,4-tetramethoxybutane diisocyanate, 1,4-butane diisocyanate, 1,6-hexane diisocyanate (HDI), 1,6-diisocyanato-2,2,4-trimethylhexane, 1,6-diisocyanato-2,4,4-trimethylhexane, lysine diisocyanate as well as 1,12-dodecane diisocyanate (C₁₂DI). An isocyanate that is used in particularly preferred manner is MDI.

By way of polyols in this connection, use may be made of a large number of polyhydroxy compounds of relatively high molecular weight. Preferentially suitable by way of polyols are the vitreously solid/amorphous or crystalline polyhydroxy compounds that are liquid at room temperature with two or three, respectively, hydroxyl groups per molecule within the molecular-weight range from 400 to 60,000, preferably within the range from 1,000 to 30,000. Examples are difunctional and/or trifunctional polypropylene glycols; random and/or block copolymers of ethylene oxide and propylene oxide may also be employed. A further group of polyethers to be employed preferentially are the polytetramethylene glycols (poly(oxytetramethylene)glycol, poly-THF) which are produced, for example, by the acidic polymerisation of tetrahydrofuran; in this case the molecular-weight range of the polytetramethylene glycols lies between 600 and 6,000, preferably within the range from 800 to 5,000.

Suitable furthermore by way of polyols are the liquid, vitreously amorphous or crystalline polyesters that can be produced by condensation of dicarboxylic or tricarboxylic acids such as, for example, adipic acid, sebacic acid, glutaric acid, azelaic acid, suberic acid, undecanedioic acid, dodecanedioic acid, 3,3-dimethylglutaric acid, terephthalic acid, isophthalic acid, hexahydrophthalic acid, dimer fatty acid or mixtures thereof with low-molecular diols or triols such as, for example, ethylene glycol, propylene glycol, diethylene glycol, triethylene glycol, dipropylene glycol, 1,4-butanediol, 1,6-hexanediol, 1,8-octanediol, 1,10-decanediol, 1,12-dodecanediol, dimer fatty alcohol, glycerin, trimethylolpropane or mixtures thereof.

A further group of the polyols to be employed in accordance with the invention are the polyesters based on ε-caprolactone, also called “polycaprolactones”.

But use can also be made of polyester polyols of oleochemical origin. Such polyester polyols can, for example, by produced by complete ring opening of epoxidized triglycerides of an at least partially olefinically unsaturated fatty-acid-containing fat mixture with one or more alcohols with 1 to 12 C atoms and subsequent partial transesterification of the triglyceride derivatives to form alkyl ester polyols with 1 to 12 C atoms in the alkyl residue. Further suitable polyols are polycarbonate polyols and dimer diols (produced by Henkel) as well as castor oil and the derivatives thereof. The hydroxy-functional polybutadienes, such as are available, for example, under the trade name “Poly-bd”, may also be employed by way of polyols for the compositions according to the invention.

Suitable furthermore by way of polyols are linear and/or weakly branched acrylic-ester copolymer polyols which, for example, can be produced by the radical copolymerisation of acrylic esters or methacrylic esters with hydroxy-functional compounds of acrylic acid and/or of methacrylic acid, such as hydroxyethyl (meth)acrylate or hydroxypropyl (meth)acrylate. On account of this manner of production, the hydroxyl groups in these polyols are, as a rule, randomly distributed, so that in this case it is a question either of linear polyols or of weakly branched polyols with an average hydroxyl functionality. Although the difunctional compounds are preferred for the polyols, use can also be made of polyols of higher functionality, at least in subordinate amounts.

The polyurethane-adhesive compositions to be used in accordance with the invention can, in a particularly preferred embodiment, a polyurethane composition with no content, or very low content, of monomeric, low-molecular diisocyanates be employed. Such hot-melt-adhesive compositions are, for example, the subject-matter of WO 01/40342. The teaching of this application with regard to the compositions having low residual monomer content is expressly the subject-matter of the present invention.

The compositions to be used in accordance with the invention may, optionally in addition, contain catalysts that accelerate the formation of the polyurethane prepolymer in the course of its production and/or the crosslinking under the influence of moisture after application of the adhesive. Suitable in this connection by way of catalysts that can be employed in accordance with the invention are, in particular, the catalysts named in the aforementioned WO 01/40342 on pages 11 to 13, in the amounts specified therein.

Moreover, the composition according to the invention may, optionally in addition, contain stabilisers, coupling additives such as tackifying resins, fillers, pigments, plasticisers and/or non-reactive thermoplastic polymers. To be understood as being “stabilisers” in the sense of this invention are, on the one hand, stabilisers that bring about stability of the viscosity of the polyurethane prepolymer during production, storage and application. Suitable for this purpose are, for example, monofunctional carboxylic acid chlorides, monofunctional highly reactive isocyanates, but also non-corrosive inorganic acids; in exemplary manner, mention may be made of benzoyl chloride, toluenesulfonyl isocyanate, phosphoric acid or phosphorous acid. Furthermore, anti-oxidants, UV stabilisers or hydrolysis stabilisers are to be understood as being stabilisers in the sense of this invention. The selection of these stabilisers is guided, on the one hand, by the main components of the composition and, on the other hand, by the application conditions as well as the loadings of the cured product to be expected. If the polyurethane prepolymer is synthesised predominantly from polyether structural units, anti-oxidants, optionally in combination with UV-screening agents, are principally necessary. Examples of these are the commercially available sterically hindered phenols and/or thioethers and/or substituted benzotriazoles or the sterically hindered amines of the HALS type (“Hindered Amine Light Stabilizer”). If substantial constituents of the polyurethane prepolymer consist of polyester structural units, hydrolysis stabilisers, e.g. of the carbodiimide type, may be employed.

The type and quantity of the vitreously solid/amorphous or crystalline polyhydroxy compounds that are liquid at room temperature, as well as the molecular weight thereof and the stoichiometric ratio of total hydroxyl groups to isocyanate groups of the diisocyanates or polyisocyanates of the hot-melt adhesives to be used in accordance with the invention, are in this case selected in such a way that the hot-melt-adhesive composition exhibits a softening-point according to ASTM E28 between 90° C. and 160° C., preferably between 100° C. and 150° C., in particularly preferred manner between 110° C. and 130° C. All the constituents of the composition are, in addition, selected in such a way that they are not capable of being extracted from the cured hot-melt adhesive by aqueous alcoholic solutions or acids, or are only capable of being extracted to a negligibly slight extent. By this means it is guaranteed that the binding agent can be given the relevant food-regulation licence, e.g. as per the FDA.

By virtue of the high softening-point of the uncured reactive hot-melt adhesive and also by virtue of a Shore hardness of the cured adhesive in the Shore-D range from 40-60, a resistance of the bonded joint to boiling water is guaranteed just a short time after the cork mouldings have been joined. In addition, the bonded joint exhibits sufficiently high strength for further processing (grindability of the adhesion-bonded moulding). In comparison with the state of the art, this enables high efficiency of cork production using manufacturing machines at a rate of 5,000 corks/hour up to more than 10,000 corks/hour.

It is possible, moreover, to use reactive hot-melt adhesives in granulate form according to the teaching of the still unpublished DE 10122437.0 for the purpose of producing the cork stoppers.

The following Examples are intended to serve for more detailed elucidation of the invention; they are of exemplary character only and do not cover the entire range of the use, according to the invention, of reactive hot-melt adhesives for the production of cork mouldings. From the particulars specified above, however, a person skilled in the art can readily infer the entire range of application of the invention.

### EXAMPLES

A hot-melt adhesive was produced from 41 parts by weight of a polyester polyol formed from hexanediol, terephthalic acid and adipic acid with a hydroxyl value of 30.5 and a softening-point of 130° C. (ring and ball), 18 parts of a C9 hydrocarbon resin, 10 parts of a liquid polyester, hydroxyl value 105, 8 parts of a prepolymer formed from polycaprolactone and MDI, 6 parts of a polypropylene glycol (molecular weight 1,000), 5 parts of an ethylene/vinyl-acetate copolymer (VA proportion 28%), 10 parts MDI and also 2 parts of a polyethylene preparation in C14 alcohols. This hot-melt adhesive had the following characteristic properties:

| | |
|---|---|
| Softening-point [°C.] | 118 |
| Viscosity [mPa.s] @ 130° C. | about 60,000 |
| Viscosity [mPa.s] @150° C. | about 30,000 |
| Tensile strength [N/mm²] after 30 min | 3 |
| Extension [%] after 30 min | 125 |
| Tensile strength [N/mm²] after 7 days | 34 |
| Extension [%] after 7 days | 500 |

With the hot-melt adhesive described above, mouldings made of agglomerated cork were adhesion-bonded on both end faces to discs made of natural cork. In tensile shear strengths the bonded joints showed a fracture in the cork substrate in each test.

6 hours after adhesion bonding, the bonded joints passed the boiling-water test for up to 2 hours. It has therefore been shown that the hot-melt adhesive described above is outstandingly suitable for adhesion-bonding mouldings made of agglomerated cork to discs of natural cork.

1. Use of a reactive hot-melt adhesive with a softening-point according to ASTM E28 between 90° C. and 160° C. for the production of cork stoppers.

2. Use according to claim 1, characterised in that a moulding made of agglomerated cork is adhesion-bonded to one or two discs made of natural cork with the aid of the reactive hot-melt adhesive.

3. Process for the production of cork stoppers, characterised by the following essential process steps:
a) application of a reactive polyurethane hot-melt adhesive with a softening-point between 90° C. and 160° C., preferably between 100° C. and 150° C., in particularly preferred manner between 110° C. and 130° C., with the aid of a die or a punch, in the manner of screen printing, through appropriately shaped perforated plates pertaining to the application punch onto at least one end face of a moulding made of agglomerated cork,
b) joining of a cork disc made of natural cork onto the adhesive-wetted end face(s) of the moulding,
c) optionally, mechanical aftertreatment of the bonded moulding by grinding or cutting.

4. Use of adhesion-bonded corks produced in accordance with claim 3 for the sealing of beverage bottles, in particular wine bottles or sparkling-wine bottles.
